(19) United States
(12) Patent Application Publication
(10) Pub. No.: US 2001/0040374 A1
(43) Pub. Date: Nov. 15, 2001

(54) DRILL PIPE ASSEMBLY

(76) Inventor: JAMES W. BREIHAN, HOUSTON, TX (US)

Correspondence Address: C. JAMES BUSHMAN, BROWNING BUSHMAN, 5718 WESTHEIMER, SUITE 1800, HOUSTON, TX, 77057

(21) Appl. No.: 09/283,667

(22) Filed: Apr. 1, 1999

(51) Int. Cl. F16L 35/00; F16L 55/00

(52) U.S. Cl. 285/93

(57) ABSTRACT

A drill pipe assembly having an elongate tubular pipe section with a first end and a second end, a first threaded tool joint having an outer surface and being attached to the first end of the pipe section, a second threaded tool joint having an outer surface and being attached to the second end of the pipe section, one of the first and second tool joints having at least one radially outwardly facing annular groove formed in the outer surface thereof and a ring of elastomeric material received in the groove, the ring having a radially inner surface and a radially outer surface, the ring preferably having an index signifying a characteristic of the drill pipe.

### BACKGROUND OF THE INVENTION

1. Field of the Invention

The present invention relates to tubular products and, more particularly, to a drill pipe assembly.

2. Description of the Prior Art

In the drilling of oil and gas wells and other earth boreholes, various types of drill pipe are employed, depending on a number of factors, such as depth of the well, size of the borehole to be drilled, downhole conditions to be encountered, etc. In particular, the drill pipe used in the drilling of oil and gas wells is available in several grades, each grade generally reflecting the tensile strength of the pipe. There are other characteristics or features of the drill pipe that are also desirable to know, such as weight, wall thickness, whether the drill pipe has been hydro-tested, etc.

It is common in the case of drill pipe, particularly drill pipe used for the drilling of oil and gas wells, to indicate the grade by milling a flat on one of the tool joints and then metal stenciling the flat with some index representative of the grade. It will be readily apparent that this form of marking requires a close examination of the tool joint and clearly is not readily visible from any distance. Another form of marking used with drill pipe to indicate grade is to mill one or more annular grooves into the outer surface of the tool joint, the number of grooves signifying the grade. The disadvantage of using grooves is that they consume tong space on the tool joint. Furthermore, they do not adequately differentiate high strength grades. Additionally, the groove(s) have sharp edges formed on the outer surface of the tool joint that contribute to the tearing of rubber products such as the ram rubbers in a blowout preventer.

### SUMMARY OF THE INVENTION

It is therefore an object of the present invention to provide a drill pipe assembly having an index that readily identifies a characteristic of the drill pipe.

Another object of the present invention is to provide a drill pipe assembly, including an index signifying a characteristic of the drill pipe and that is readily visible.

Another object of the present invention is to provide a drill pipe assembly, including an easily replaceable index.

A further object of the present invention is to provide a drill pipe assembly that eliminates sharp edges on the tool joint.

The above and other objects of the present invention will become apparent from the drawings, the description given herein, and the appended claims.

According to the present invention, there is provided a drill pipe assembly having a tubular, pipe section with a first end and a second end, a first tool joint attached to the first end of the drill pipe section, and a second tool joint attached to the second end of the drill pipe section. The tool joints are threaded, one of the tool joints preferably forming a pin connection, the other tool joint forming a box connection. Each of the tool joints has an outer surface in at least one of which is formed at least one annular, radially outwardly facing groove. An elastomeric ring is received in the annular groove, the ring preferably substantially filling the groove. Preferably, the ring has an index.

### DESCRIPTION OF THE DRAWINGS

FIG. 1 is an elevational view showing one embodiment of the drill pipe assembly of the present invention; and

FIG. 2 is an enlarged view, partly in section, of the drill pipe assembly of FIG. 1.

### DESCRIPTION OF THE PREFERRED EMBODIMENTS

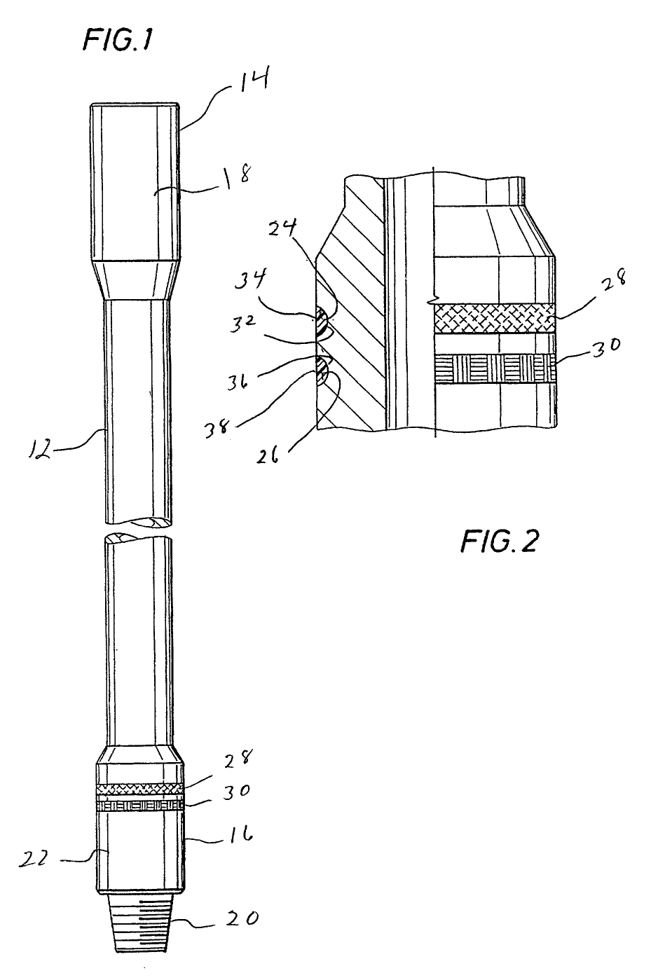

With reference first to FIG. 1, it can be seen that the drill pipe assembly of the present invention, shown generally as 10, includes a tubular pipe section 12, a first tool joint 14, and a second tool joint 16, tool joints 14 and 16 being connected to opposite ends of pipe section 12. Tool joint 14, which forms an internally threaded box connection (not shown), has an outer, generally cylindrical surface 18 while tool joint 16, which forms a threaded pin connection 20, has an outer, generally cylindrical surface 22. As best seen with reference to FIG. 2, tool joint 16 has first and second axially spaced annular grooves 24 and 26, which, as seen, are radiused so as to be generally semicircular when viewed in transverse cross-section. Received in first annular groove 24 is an elastomeric ring 28 while a second elastomeric ring 30 is received in second annular groove 26. As best seen in FIG. 2, first ring 28 has an inner surface 32 that is complementary in shape to groove 28 and an outer surface 34 that is generally cylindrical. Likewise, ring 30 has an inner surface 36 that is complementary in shape to groove 26 and an outer surface 38 that is generally cylindrical and flush with outer surface 22.

As shown, first ring 28 is lined for the color orange while second ring 30 is lined for alternating red and blue colors.

The colors, orange as to first ring 28 and alternating red and blue as to ring 30, are on the outer surfaces 34 and 38 of rings 28 and 30, respectively, although it will be appreciated that the colors generally will extend throughout rings 28 and 30; i.e., ring 28 will be uniformly orange throughout its structure, and ring 30 will have alternating sections of red and blue, which make up its structure. The colors on the rings 28 and 30 serve as indices in the sense that they can visually convey information regarding some known feature, characteristic, or history of the drill pipe.

As used herein, the words “index” or “indices” refer to any color, color scheme, marking, pattern, configuration, or other physical appearance of the ring that can serve to identify, confirm, indicate, characterize, signify, or in any other fashion, visually or by touch, convey some characteristic, feature, history, etc., of the drill pipe—i.e., provide any information about the drill pipe. Thus, while a color or color scheme, as shown in FIGS. 1 and 2, can be used, other indices can include a pattern on the outer surface of the ring, a predetermined, characteristic shape of the ring, a marking or markings on the rings, etc. Most commonly, the index or indices will be visual in nature, e.g., will comprise a color or colors that are, at least, on the outer surface of the ring and that generally form the complete color or colors of the ring. Thus, for example, in the embodiment shown in FIGS. 1 and 2, the ring 28 would be orange throughout while the ring 30 would be a ring made from alternating red and blue sections that extended from the outer to the inner surface of the ring.

Although in the embodiment shown in FIGS. 1 and 2 there are two grooves and two rings, in the usual case there will only be one groove and one ring and, in still a more general case, the ring will be of a single color, e.g., orange. Also, while in the embodiment shown in FIGS. 1 and 2, grooves and rings are on the tool joint forming the pin connection, the grooves and rings can be on the tool joint forming the box section, and, in certain cases, it may be desirable to have one or more grooves on both the pin and box connections, a ring being received in each of the grooves.

While as shown and when viewed in transverse cross-section the rings have a generally semicircular configuration with a generally cylindrical outer surface and a radiused or convex inner surface, it will be appreciated that the ring can have numerous cross-sectional shapes, depending on the cross-sectional shape of the groove, whether the shape of the ring is being used as an index, etc. For example, if the outer surface of the ring were embossed with a raised or relief pattern to serve as an index, then the outer surface of the ring would not be strictly cylindrical. Further, instead of having the configuration as shown—i.e., a semicircle when viewed in transverse cross-section, the ring could be circular in transverse cross-section such that a convex surface of the ring was projecting out of the cylindrical surface of the tool joint.

The index on the ring can convey characteristics of the drill pipe, such as grade, which generally includes tensile strength; weight; wall thickness; materials of construction; testing history, e.g., whether or not the pipe was hydro-tested; degree of usage—i.e., how many times the drill pipe has been run in and out of a well; and virtually any other feature, characteristic, or history of the drill pipe that needs to be, or would be desirable to be, known prior to using the drill pipe. In using the index, there is provided a correlation of the particular index with the particular characteristic, feature, or history of the drill pipe. Thus, for example, the color orange would designate a particular grade, the color yellow would designate a different grade, etc. It will be apparent that a single color could also be correlated not only with the grade, but also with other characteristics, e.g., wall thickness, prior testing, etc. In general, it will be readily apparent that a single color in a single groove can be used to convey a minimal amount of information about the drill pipe, e.g., grade, or a substantial amount of information about the drill pipe, e.g., grade, wall thickness, weight, etc. Thus, many combinations of the index, and various characteristic(s), feature(s), or history of the drill pipe, can be employed. Since the index effectively conveys the information about the drill pipe visually or by touch, one need only know what the particular index means, either from memory or from a suitable source that gives the correlation of index/characteristic(s), to determine the nature or details of the information.

As noted above, the present invention also contemplates a drill pipe assembly wherein the elastomeric ring, rather than being provided with an index to indicate some characteristic or provide some information about the drill pipe, is used merely to fill the groove and effectively eliminate any sharp edges formed at the intersection of the groove side walls and the outer surface of the tool joint. In this regard, the invention provides a way to retrofit used drill pipe to eliminate these sharp edges. As discussed previously, one prior art way of indicating grade of the drill pipe was the use of one or more annular grooves in the tool joint. It is not uncommon for drill pipe, in addition to the grooves, to also have an alternate means of marking the grade, such as, for example, metal stenciling on a flat milled in the tool joint or a brass button or other metallic button marked with the grade press-fitted into a fitted recess milled in the outer surface of the tool joint. The latter methods possess the inherent disadvantage that the information is not readily visible except upon close inspection of the drill pipe. On the other hand, the former method leaves the tool joint with sharp edges formed by the grooves that can damage the rubber elements of blowout preventers and other soft components that may engage the drill pipe during the drilling operation. To obviate this problem, it has been common to fill the groove(s) with weld material so as to provide a smooth surface and rely on the metal stenciling or brass button to identify the grade of the drill pipe. Filling the groove(s) with weld material is labor-intensive, time-consuming, and therefore expensive. By utilizing one aspect of the present invention wherein the groove and elastomeric ring is positioned in the groove such that the groove is substantially filled to the extent that the sharp edges defining the groove are effectively eliminated, one obviates the need for welding. Thus, it will be appreciated that, while there may be a ring and an index on the ring, if the only desire is to fill the groove and eliminate sharp edges on the tool joint, no indexing is necessary. Conversely, if the only desire is to provide an index, the ring need not necessarily fill the groove.

The rings that are used in the assembly of the present invention are made from an elastomeric material. The term “elastomeric material” as used herein refers to a material that, in general, changes its shape and size under the action of opposing forces but recovers its original configuration when the forces are removed. More specifically, the elastomeric materials from which the rings of the present invention are made will possess sufficient memory such that they can be stretched enough to encircle the tool joint and, once positioned over the groove, will contract to or toward their original shape so as to tightly engage the groove in encircling relationship to the tool joint. A wide variety of natural, synthetic, thermoplastic, and thermosetting elastomeric materials may be employed, depending upon the particular downhole conditions encountered. In many cases, the elastomeric material will be material that has high temperature, e.g., above 200° F., stability, is resistant to chemical attack, and has good oil resistance. Non-limiting examples of suitable elastomers that can be employed include elastomeric polyurethane, natural rubber, chloroprene, styrene rubber, nitrile rubber, butyl rubber, silicone rubber, chlorosulfonated polyethylene, fluoroelastomers, polyvinylchloride elastomers, etc. In general, virtually any material that is elastomer as described above can be employed. A preferred material for making the rings for use in the assembly of the present invention is a polyurethane elastomer. Polyurethane elastomers exhibit good resistance to elevated temperatures, oils, and chemicals, such as oxidizing chemicals.

The rings of the present invention can be made by techniques well known to those skilled in the art, such as injection molding, compression molding, extrusion, etc. While clearly in the preferred embodiment the rings are endless, it is contemplated that a predetermined length of a strip of the elastomeric material could be employed to form the ring in situ on the tool joint, there being a suitable technique such as mechanically interlocking, gluing, or otherwise affixing the ends of the strip together when the ring is positioned in the groove.

The foregoing description and examples illustrate selected embodiments of the present invention. In light thereof, variations and modifications will be suggested to one skilled in the art, all of which are in the spirit and purview of this invention.

What is claimed is:

1. A drill pipe assembly comprising:
an elongate, tubular pipe section having a first end and a second end;
a first, threaded tool joint having an outer surface and being attached to said first end of said pipe section;
a second, threaded tool joint having an outer surface and being attached to said second end of said pipe section;
at least one of said first and second tool joints having at least one radially outwardly facing, annular groove formed in the outer surface thereof;
a ring of elastomeric material received in said at least one groove; and
an index on said ring.

2. The assembly of claim 1 wherein said first tool joint comprises a box connection and said second tool joint comprises a pin connection.

3. The assembly of claim 2 wherein said groove and said ring are on said pin connection.

4. The assembly of claim 1 wherein said ring has a radially inner surface and a radially outer surface.

5. The assembly of claim 1 wherein said index comprises a first color.

6. The assembly of claim 1 wherein said index comprises a first and a second color.

7. The assembly of claim 1 wherein said groove has a radiused curvature.

8. The assembly of claim 7 wherein said ring has a radially inner surface and a radially outer surface.

9. The assembly of claim 8 wherein said radially inner surface of said ring has a shape complementary to said groove.

10. The assembly of claim 8 wherein said radially outer surface of said ring is cylindrical.

11. The assembly of claim 1 wherein there are a plurality of said grooves and said rings.

12. The assembly of claim 4 wherein said index is on said outer surface of said ring.

13. A drill pipe assembly comprising:
an elongate, tubular pipe section having a first end and a second end;
a first, threaded tool joint having an outer surface and being attached to said first end of said pipe section;
a second, threaded tool joint having an outer surface and being attached to said second end of said pipe section;
at least one of said first and second tool joints having at least one radially outwardly facing, annular groove formed in the outer surface thereof; and
a ring of elastomeric material received in and substantially filling said at least one groove.

14. The assembly of claim 13 wherein said first tool joint comprises a box connection and said second tool joint comprises a pin connection.

15. The assembly of claim 14 wherein said groove and said ring are on said pin connection.

16. The assembly of claim 13 wherein said ring has a radially inner surface and a radially outer surface.

17. The assembly of claim 13 wherein said groove has a radiused curvature.

18. The assembly of claim 17 wherein said ring has a radially inner surface and a radially outer surface.

19. The assembly of claim 18 wherein said radially inner surface of said ring has a shape complementary to said groove.

20. The assembly of claim 18 wherein said radially outer surface of said ring is cylindrical.

21. The assembly of claim 13 wherein there is a plurality of said grooves in said rings.

22. The assembly of claim 1 or 13 wherein said ring comprises an endless member.
